(19) United States
(12) Patent Application Publication
(10) Pub. No.: US 2022/0027294 A1
(43) Pub. Date: Jan. 27, 2022

(54) STORAGE CARD AND STORAGE DEVICE

(71) Applicants: MemRay Corporation, Gyeonggi-do (KR); Korea Advanced Institute of Science and Technology, Daejeon (KR)

(72) Inventors: Myoungsoo Jung, Daejeon (KR); Gyuyoung Park, Daejeon (KR)

(21) Appl. No.: 17/382,863

(22) Filed: Jul. 22, 2021

(30) Foreign Application Priority Data
Jul. 23, 2020 (KR) 10-2020-0091567
May 7, 2021 (KR) 10-2021-0059050

(51) Int. Cl. G06F 13/16; G06F 13/42

(52) U.S. Cl. CPC G06F 13/1668; G06F 2213/0026; G06F 13/4282

(57) ABSTRACT

In a storage card, a first module exposes a set of registers including a first register to the host through a configuration space of a host interface, and the first register is written when the host submits a command of an I/O request to the host memory. A second module fetches the command from the host memory when the first register is written. A third module detects a location of the host memory based on a host memory address of request information in response to signaling of the second module, and performs a transfer of target data between the host memory and a memory controller. A fourth module writes a completion event to the host memory through the configuration space in response to service completion of the I/O request in the third module, and informs the host about I/O completion by writing an interrupt.

### CROSS-REFERENCE TO RELATED APPLICATION

This application claims priority to and the benefit of Korean Patent Application No. 10-2020-0091567 filed in the Korean Intellectual Property Office on Jul. 23, 2020, and Korean Patent Application No. 10-2021-0059050 filed in the Korean Intellectual Property Office on May 7, 2021, the entire contents of which are incorporated herein by reference.

### BACKGROUND

### (a) Field

The described technology generally relates to a storage card and a storage device.

### (b) Description of the Related Art

Solid state drives (SSDs) become major storage media in diverse computing domains thanks to their performance superiority and high storage density. While flash-based SSDs are yet faster than spinning disks, the trend of major memory vendors is to make flash denser rather than faster by stacking multiple flash layers and/or putting more bit presentations per bit.

New memories such as a phase-change random-access memory (PRAM), a magnetoresistive random-access memory (MRAM) and 3D-Xpoint provides ultra-low latency, which is a way faster than flash. While the new memory Can be a very promising storage backend to realize the fast storage card, there are several challenges to be addressed. In particular, firmware execution does not cause degradation on a critical path by far as its computation bursts can be fully hidden behind slow storage media such as flash. However, since the new memory reduces access latency by 99.9% compared to the traditional flash, the firmware become a major contributor of SSD internal I/O processing times. It is observed that the firmware latency account for 98% of a total I/O service time when dual core processor with the new memory is applied in a real system.

Many-core and/or high-performance processors may be employed to mitigate the firmware latency issue on the design of fast storage cards is to employ.

However, using the many-core processors can be expensive. Further, the firmware execution with high-performance processors can also exhibit high operating temperature issues.

### SUMMARY

Some embodiments may provide a storage card and a storage device capable of reducing or eliminating latency according to firmware execution.

According to an embodiment, a storage card configured to connect a non-volatile memory module and a host including a processor and a host memory is provided. The storage card includes a first module, a second module, a third module, and a fourth module. The first module exposes a set of registers including a first register to the host through a configuration space of a host interface for connection with the host, the first resister being written when the host submits a command of an I/O (input/output) request to the host memory. The second module fetches the command from the host memory when the first register is written. The third module detects a location of the host memory based on a host memory address of request information included in the command in response to signaling of the second module, and performs a transfer of target data for the I/O request between the host memory and a memory controller for the non-volatile memory module. The fourth module writes a completion event to the host memory through the configuration space in response to service completion of the I/O request in the third module, and informs the host about I/O completion by writing an interrupt.

In some embodiments, the first module, the second module, the third module, and the fourth module may be implemented as hardware.

In some embodiments, the first module, the second module, the third module, and the tburth module may be implemented as the hardware at a register transfer level (RTL).

In some embodiments, the first module, the second module, the third module, and the fourth module may be connected by an internal memory bus of the storage card.

in some embodiments, the host interface may include a peripheral component interconnect express (PCIe) interface, and the configuration space may include base address registers (BARs).

In some embodiments, the set of registers may further include a second register, and the second register may be written in response to the fourth module notifying the host of completion of the I/O request.

in some embodiments, the third module may translate a logical address of the request information into a physical address of the non-volatile memory module.

In some embodiments, the host memory address may include a PRP (physical region page).

In some embodiments, the third module may include a plurality of I/O engines, and the plurality of I/O engines may include a read engine that reads data from the non-volatile memory module, and a write engine that writes data to the non--volatile memory module.

In some embodiments, each I/O engine may include a plurality of submodules. The the plurality of submodules may include a first submodule that extracts information including an operation code indicating a read or a write, a PRP, and a logical address from the request information received from the second module, composes a descriptor including the operation code, a source address, and a destination address based on the extracted information, and sends a signal indicating the service completion to the fourth module when receiving a completion event, and at least one second submodule that receives the descriptor from the first submodule, performs the transfer of the target data between the host memory and the memory controller based on the descriptor, and returns the completion event to the first submodule when the transfer is completed.

In some embodiments, the plurality of submodules may further include a third submodule. When the PRP includes PRP1 and PRP2, the first submodule may transfer the PRP2 to the third submodule, and the third submodule may fetch a PRP list indicated by the PRP2 from the host memory and transfers the PRP list to the first submodule. Further, the first submodule may set the source address or destination address based on the PRP1 and the PRP list.

In some embodiments, the at least one second submodule includes a plurality of second submodules corresponding to a plurality of channels for the memory controller, respectively, and the first submodule may transfer the descriptor to a target second submodule among the plurality of second submodules.

In some embodiments, the first submodule may split a block of the target data into a plurality of data chunks, and assign the plurality of data chunks to the plurality of second submodules.

In some embodiments, the first module, the second module, the third module, and the fourth module may be connected to the host interface through a first type of memory bus, the plurality of submodules may be connected to each other through a second type of memory bus, and the third module may be connected to the second module and the fourth module through the second type of memory bus.

In some embodiments, the first type of memory bus may include an advanced extensible interface (AXI) bus, and the second type of memory bus may include an AXI stream bus.

In some embodiments, the non-volatile memory module may include a plurality of memory modules, the memory controller may include a plurality of memory controllers connected to the plurality of memory modules, respectively, and the plurality of memory controllers may be connected to the plurality of channels, respectively.

In some embodiments, the read engine may be connected to a write port of the host interface through a first write channel, and is connected to a read port of the memory controller through a first read channel, and the write engine may be connected to a read port of the host interface through a second read channel, and is connected to a write port of the memory controller through a second write channel. In this case, the first write channel and the first read channel may be connected by a first unidirectional bus, and the second read channel and the second write channel may be connected by a second unidirectional bus.

In some embodiments, AXI buses may be split into the first write channel and the first read channel, and split into the second write channel and the second read channel, and the first and second unidirectional buses may include AXI stream buses.

According to another embodiment, a storage card configured to connect a non-volatile memory module and a host including a processor and a host memory is provided. The storage card includes a memory controller connected to non-volatile memory module, a first module, a second module, a third module, and a fourth module. The first module exposes a set of registers to the host through BARs of a PCIe interface, and the second module fetches a command of an I/O request from the host memory when the set of registers is written. The third module detects a location of the host memory based on a PRP of request information included in the command in response to signaling of the second module, and performs a transfer of target data for the I/O request between the host memory and the memory controller. The fourth module writes a completion event to the host memory through the BARs in response to service completion of the I/O request in the third module, and informs the host about I/O completion by writing an interrupt. The first module, the second module, the third module, and the fourth module are implemented as hardware.

According to yet another embodiment, a storage device configured to be connected to a host including a processor and a host memory is provided. The storage device includes a non-volatile memory module, a memory controller connected to non-volatile memory module, a first module, a second module, a third module, and a fourth module. The first module exposes a set of registers including a first register to the host through a configuration space of a host interface for connection with the host, the first register being written when the host submits a command of an I/O request to the host memory. The second module fetches the command from. the host memory when the first register is written. The third module detects a location of the host memory based on a host memory address of request information included in the command in response to signaling of the second module, and performs a transfer of target data for the I/O request between the host memory and a memory controller for the non-volatile memory module. The fourth module writes a completion event to the host memory through the configuration space in response to service completion of the I/O request in the third module, and informs the host about I/O completion by writing an interrupt.

### BRIEF DESCRIPTION OF THE DRAWINGS

FIG. 1 is an example block diagram of a computing device according to an embodiment.

FIG. 2 is a block diagram of a typical storage device.

FIG. 3 is an example block diagram of a storage device according to an embodiment.

FIG. 4 is a diagram showing an example operation of a storage device according to an embodiment.

FIG. 5 and FIG. 6 are drawings showing various examples of an AXI interface of a direct I/O module of a storage card according to an embodiment.

FIG. 7 is a diagram showing an example of a direct I/O module of a storage card according to an embodiment.

FIG. 8 is a diagram showing an example of data transfers in a storage device according to an embodiment.

FIG. 9 is a diagram for explaining an example of wear-leveling in a storage device according to an embodiment.

FIG. 10 is a diagram showing an example of a memory controller and a backend memory module of a storage device according to an embodiment.

### DETAILED DESCRIPTION OF THE EMBODIMENTS

In the following detailed description, only certain example embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

As used herein, the singular forms “a”, “an” and “the” are intended to include the plural forms as well, unless the context clearly indicates otherwise.

The sequence of operations or steps is not limited to the order presented in the claims or figgures unless specifically indicated otherwise. The order of operations or steps may he changed, several operations or steps may be merged, a certain operation or step may be divided, and a specific operation or step may not he performed.

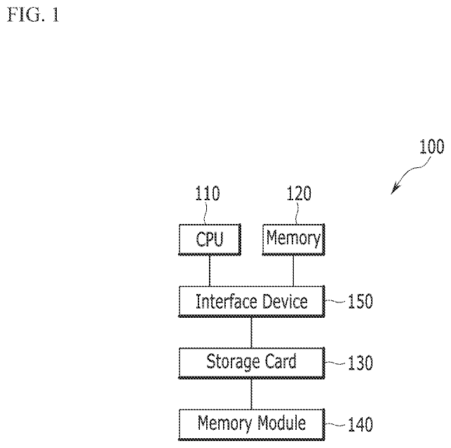

FIG. 1 is an example block diagram of a computing device according to an embodiment.

Referring to FIG. 1, a computing device 100 includes a processor 110, a memory 120, a storage card 130, and a memory module 140. FIG. 1 shows an example of the computing device, and the computing device may be implemented by various structures.

In some embodiments, the computing device may be any of various types of computing devices. The various types of computing devices may include a mobile phone such as a smartphone, a tablet computer, a laptop computer, a desktop computer, a multimedia player, a game console, a television, and various types of Internet of Things (IoT) devices.

The processor 110 performs various operations (e.g., operations such as arithmetic, logic, controlling, and input/output (I/O) operations) by executing instructions. The processor may be, for example, a central processing unit (CPU), a graphics processing unit (GPU), a microprocessor, or an application processor (AP), but is not limited thereto. Hereinafter, the processor 110 is described as a CPU 110.

The memory 120 is a system memory that is accessed and used by the CPU 110, and may be, for example, a dynamic random-access memory (DRAM). In some embodiments, the CPU 110 and the memory 120 may be connected via a system bus. A system including the CPU 110 and the memory 120 may be referred to as a host. The memory 120 may be referred to as a host memory.

The memory module 140 is a non-volatile memory-based memory module. In some embodiments, the memory module 140 may be a resistance switching memory based memory module. In one embodiment, the resistance switching memory may include a phase-change memory (PCM) using a resistivity of a storage medium (phase-change material), for example, a phase-change random-access memory (PRAM). In another embodiment, the resistance switching memory may include a resistive memory using a resistance of a memory device, or magnetoresistive memory, for example, a magnetoresistive random-access memory (MRAM). Hereinafter, the memory used in the memory module 140 is described as a PRAM.

The storage card 130 connects the host including the CPU 110 and the memory 120 to the memory module 140. In some embodiments, the storage card 130 may use a non-volatile memory express (NVMe) protocol as a protocol for accessing the non-volatile memory-based memory module 140. Hereinafter, the protocol is described as the NVMe protocol, but embodiments are not limited thereto and other protocols may be used.

In some embodiments, the storage card 130 may be connected to the host through a host interface. In some embodiments, the host interface may include a peripheral component interconnect express (PCIe) interface. Hereinafter, the host interface is described as a PCIe interface, but embodiments are not limited thereto and other host interfaces may be used.

In some embodiments, the computing device 100 may further include an interface device 150 for connecting the storage card 130 to the host including the CPU 110 and the memory 120. In some embodiments, the interface device 150 may include a root complex 150 that connects the host and the storage card 130 in a PCIe system.

First, a typical storage device is described with reference to HG. 2.

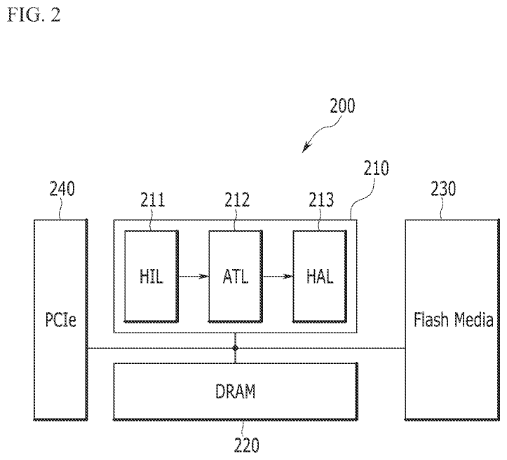

FIG. 2 is a block diagram of a typical storage device. For convenience of description, FIG. 2 shows an example of an SSD storage device to which a NAND flash memory is connected.

Referring to FIG. 2, the storage device 200 includes an embedded processor 210, an internal memory 220, and flash media 230. The storage device 200 is connected to a host through a PCIe interface 240. The storage device 200 may include a plurality of flash media 230 over multiple channels to improve parallelism and increase backend storage density. The internal memory 220, for example, an internal DRAM is used for buffering data between the host and the flash media 230. The DRAM 220 may also be used to maintain metadata of firmware running on the processor 210.

At the top of firmware stack of the processor 210, a host interface layer (HIL) 211 exists to provide a block storage compatible interface. The HIL 211 may manage multiple NVMe queues, fetches a queue entry associated with an NVMe request, and parse a command of the queue entry. When the request is a write, the HIL 211 transfers data of the write request to the DRAM 220. When the request is a read, the HIL 211 scans the DRAM 220 for serving data from the DRAM 220 directly.

Although the data may be buffered in the DRAM 220, the requests are eventually served from the flash media 230 in either a background or foreground manner. Accordingly, underneath the HIL 211, an address translation layer (ATL) 212 converts a logical block address (LBA) of the request to an address of the backend memory, i.e., the flash media 230. The ATL 212 may issue requests across multiple flash media 230 for parallelism. At the bottom of the firmware stack, a hardware abstraction layer (HAL) 213 manages memory protocol transactions for the request issued by the ATL 212.

Therefore, a design of efficient firmware takes a key role of the storage card. However, as access latency of the new non-volatile memory is about a few vs, the firmware execution becomes a critical performance bottleneck. For example, when the PRAM is used as the backend memory of the storage device, the firmware latency on an I/O datapath may account for approximately 98% of an I/O service time at a device-level. To address this issue, a processor with more cores or a high-performance processor can be used. For example, computation cycles can be distributed across multiple such that a CPU burst for firmware can he reduced and the firmware latency can be overlapped with I/O burst latency of the backend. memory. This can shorten overall latency, but many-cores and/or high-performance processors may consume more power, which may not fit well with an energy-efficient new memory based storage design. Hereinafter, embodiments for addressing this issue are described.

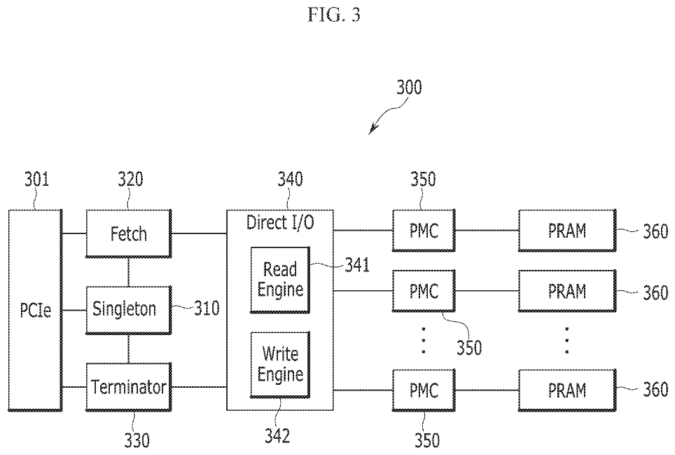

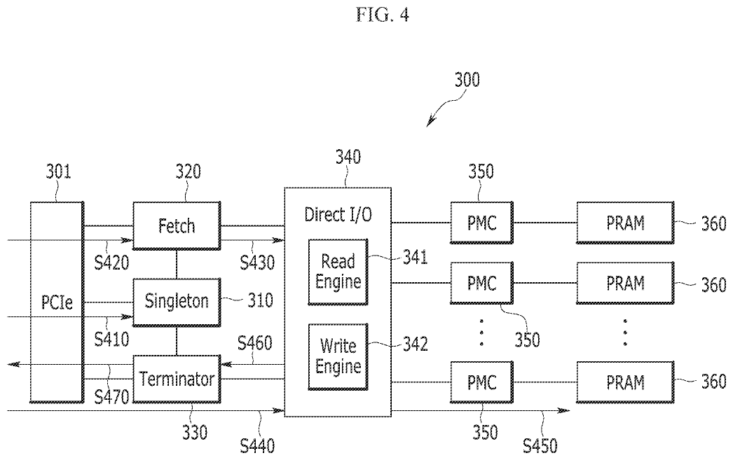

FIG. 3 is an example block diagram of a storage device according to an embodiment, and FIG. 4 is a diagram showing an example operation of a storage device according to an embodiment.

Referring to FIG. 3, a storage device 300 includes a storage card and a backend memory module 360. The storage card includes a singleton module 310, a fetch module 320, a terminator module 330, and a direct I/O module 340. In some embodiments, the singleton module 310, the fetch module 320, the terminator module 330, and the direct I/O module 340 may be implemented as hardware modules. In some embodiments, hardware modules may be pipelined. In some embodiments, the singleton module 310, the fetch module 320, the terminator module 330, and the direct I/O module 340 may be implemented in integrated circuits, tbr example field-programmable gate arrays (FPGAs). For example, the singleton module 310, the fetch module 320, the terminator module 330, and the direct I/O module 340 may be implemented on an FPGA board of Xilinx using an UltraScale™ chip and a PCIe Gen3 interface. In some embodiments, the singleton module 310, the fetch module 320, the terminator module 330, and the direct I/O module 340 may be implemented as hardware modules at a register trartsthr level (RTL).

In some embodiments, the storage card corresponds to a PCIe endpoint and may be connected to a host through a PCIe interface 301. In some embodiments, the storage card may directly connect ports of the PCIe endpoint with backend channels over the hardware modules 310 to 340 connected to an on-chip interconnect network.

In some embodiments, the storage card may not employ an internal DRAM buffer or a multi-core processor in the storage data path. Instead of having computational complex, the storage card may employ the plurality of hardware modules that can handle I/O request fetch/parses, queue management, address translation, and wear-leveling. In some embodiments, hardware automation architecture of the storage card may directly connect multiple ports of the PCIe endpoint to multiple backend memory channels through the hardware modules (e.g., RTL modules) connected to an on-chip interconnect network (e.g., internal memory bus interconnect). Each channel may employ a memory controller 350 that manages I/O granularity disparity between a host and the backend memory module 360.

The singleton module 310 manages context registers including doorbell registers. The fetch module 320 fetches a command (e.g., SQ entry) including I/O request information from a host memory (e.g., 120 of FIG. 1). The terminator module 330 notifies the host of I/O completion by generating completion information (e.g., CQ entry). In some embodiments, the HE, of the existing firmware may be implemented by hardware modules of the singleton module 310, the fetch module 320, and the terminator module 330.

Specifically, the singleton module 310 interfaces with the host and performs a management function for PCIe. In some embodiments, the singleton module 310 may interface with the host by obeying with an NVMe protocol over PCIe. The singleton module 310 configures registers and maps a set of the registers to a host address space over a configuration space of a host interface. In some embodiments, the configuration space may include PCIe base address registers (BARs). In some embodiments, the set of registers may include doorbell registers, and the doorbell registers may include a doorbell register for a submission queue (SQ) and a doorbell register for a completion queue (CQ). In this way, the singleton module 310 may configure the PCIe BARs to expose the PCIe BARs to the host. In some embodiments, the set of the registers may be exposed to the hose through the PCIe BARs. In some embodiments, the singleton module 310 may be implemented by automating a logic of a management functionality for the PCIe in the HIL. When the host submits a command corresponding to a I/O request to the queue (e.g., SQ), the host may write the doorbell register (e.g., the doorbell register for SQ) of the singleton module 310 through an update of the BARs. The fetch module 320 and the terminator module 330 may get a signal event or I/O request information when there is any of the BAR updates from the singleton module 310.

The fetch module 320 fetches the I/O request information of the host, and the terminator module 330 informs the host for I/O completion when I/O processing and data transfers are completed. In some embodiments, the fetch module 320 and the terminator module 330 may replace functionalities other than the PCIe management functionality in the HIL with hardware logic. In some embodiments, the fetch module 320 may receive a signal generated by the singleton module 310 whenever there is a write event on the doorbell register through the BARs in the singleton module 310. Then, the fetch module 320 fetches the command (e.g., SQ entry) from the queue (e.g., SQ) of the host memory 120. In some embodiments, the fetch module 320 may parse the command to generate request information. In some embodiments, the request information may include an operation code (opcode), a logical address, a size, and a host memory address. In some embodiments, the host memory address may be a physical region page (PRP). Hereinafter, the host memory address is described as the PRP. The PRP may indicate a target location of the host memory 120. In a read, the PRP may indicate a location to which target data is to be transferred. In a write, the PRP may indicate a location from which target data is to be fetched. In some embodiments, the logical address may be a logical block address (LBA). Hereinafter, the logical address is described as the LBA. For example, the LBA may indicate a logical block to be :performed (e.g., to be read or written) with an operation indicated by the operation code. The fetch module 320 signals the direct I/O module 340 for further processing of the request such as data transfers and address translation.

The direct I/O module 340 processes the request information in response to signaling from the fetch module 320. In some embodiments, the fetch module 320 may parse the command to generate request information. In some embodiments, the direct I/O module 340 may parse the command transferred from the fetch module 320 to generate the request information. The direct I/O module 340 translates the address of the I/O request into a physical address of the backend memory (i.e., an address of the PRAM module), and transfers data between the host memory 120 and the memory controller 350. In some embodiments, the direct I/O module 340 may perform direct data transfers for PCIe inbound (write) requests and PCIe outbound (read) requests. In some embodiments, the direct I/O module 340 may replace a function corresponding to an address translator layer (ATL) of the existing SSD firmware with hardware logic.

In some embodiments, the direct I/O module 340 may include a read engine 341 and a write engine 342 as I/O engines. In some embodiments, the I/O engine may include a direct media access (DMA) engine for the direct data transfer. The read engine 341 and the write engine 342 may perform data transfers in parallel. Accordingly, the interference between reads and writes from the I/O path of the hardware RTLs can be reduced. In this case, a target I/O engine may be determined from among the read engine 341 and the write engine 342 based on the operation code. That is, when the operation code indicates a read, the read engine 341 may become the target I/O engine, and when the operation code indicates a write, the write engine 342 may become the target I/O engine. The target I/O engine may parse data transfer information such as a source address and a destination address from the request information. That is, the target I/O engine may perform address translation of the I/O request. In some embodiments, when the operation code indicates the read, the source address may be an address of the backend memory module and the destination address may be an address of the host memory 120. When the operation code indicates the write, the source address may be the address of the host memory 120 and the destination address may be the address of the backend memory module. In some embodiments, the address of the host memory 120 may be set based on the PRP, and the address of the backend memory module may be set based on the logical address. The target I/O engine initiates data transfer (e.g., DMA) for all pages of the host memory 120 indicated by the PRP. In some embodiments, while performing the DMA, the address translation may be performed in a pipelined manner.

In some embodiments, the storage card may further include a PRAM memory controller (PMC) 350 that performs I/O services in the backend memory module 360, for example, the PRAM module 360. In some embodiments, the memory controller 350 may be implemented as a part of the full hardware design of the storage card.

In some embodiments, the memory controller 350 may perform I/O services directly on the backend PRAM module without the conventional DRAM buffer cache. In some embodiments, the memory controller 350 may manage the I/O granularity disparity between the host and the backend PRAM module 360.

The terminator module 330 composes a set of PCIe packets which are required to complete the I/O requests by communicating with a host-side driver (e.g., an NVMe driver). When the direct I/O module 340 signals its service completion, the terminator module 330 writes a completion event through the BARS. In some embodiments, the terminator module 330 may write the completion event to a target BAR offset as a form of an NVMe's CQ entry. Since the two NVMe queues of SQ and CQ are always paired, the terminator module 330 may detect the target BAR offset to which the CQ entry is to be written by referring to the singleton module 310. Accordingly, the CQ entry may be written to the CQ of the host memory 120. When the BAR update finishes, the terminator module 330 informs to the host about the I/O completion by writing an interrupt. In some embodiments, the terminator module 330 may inform to the host about the I/O completion by writing a message signaled interrupts (MSI) packet as an upcall interrupt associated with the I/O request. Accordingly, the host may write the doorbell register (e.g., the doorbell register for CQ) of the singleton module 310 through the BAR update. In this way, when the direct I/O module 340 and the memory controller 350 complete the I/O processing and data transfers, the terminator module 330 may inform to the host about the I/O completion through the completion region of the BARs.

The hardware modules 310 to 350 are connected to each other through an internal memory bus. In some embodiments, the memory bus may include two types of memory buses (e.g., a first type of memory bus and a second type of memory bus). In some embodiments, datapaths such as PCIe links and memory controller interfaces may be connected by the first type of memory bus, while some hardware modules may be connected through the second type of memory bus. In some embodiments, the memory bus may include an advanced extensible interface (AXI) interface. In this case, the first type of memory bus may include an AXI bus, and the second type of memory bus may include an AXI stream bus. While the AXI bus may access a specific region over an address, the AXI stream bus may be used for delivering bulk signals as a unidirectional path.

Next, an example of an operation of a storage device is described with reference to FIG. 4.

Referring to FIG. 3 and FIG. 4, a host submits a command corresponding to an I/O request to a queue (e.g., SQ), and writes a doorbell register of a singleton module 310 through a BAR update, at step S410. Based on the BAR update, the fetch module 320 fetches the command (e.g., SQ entry) including I/O request information from a host memory at step S420. In some embodiments, the fetch module 320 may parse the command to generate request information. The fetch module 320 signals a direct I/O module 340 to process the request information at step S430.

When an operation code of the request information indicates a write, the direct I/O module 340 reads target data of the I/O request from the host memory based on the request information at step S440, and writes the target data to a PRAM module 360 based on the request information at step S450. When the operation code of the request information indicates a read, the direct I/O module 340 reads the target data of the I/O request from the PRAM module 360 based on the request information, and writes the target data to the host memory based on the request information.

After completing writing the target data, the direct I/O module 340 notifies a terminator module 330 of I/O completion at step S460. The terminator module 330 sends an interrupt to the host at step S470 so that the host can complete the I/O service.

According to the above-described embodiments, it is possible to provide a storage card that removes an internal processor and buffer resources by completely automating memory processing components (various modules) over hardware. Accordingly, it is possible to reduce or eliminate latency caused by firmware execution.

In some embodiments, the storage card may convert all storage management logic for a memory into pipelined hardware modules. In some embodiments, the memory controller may perform I/O services directly on the bare PRAM package without the conventional DRAM buffer cache. In some embodiments, the storage card may expose the PRAM backend complex to the host through PCIe links. To this end, the storage card may employ the direct I/O module that perform direct data transfers for PCIe inbound and outbound requests (write and read, respectively). In some embodiments, the direct I/O module may translate the host request and the address of the corresponding system memory into the backend PRAM address, so that the NVMe request service can be directly provided without firmware involvement and assistance of computing parts. Accordingly, the storage card may not require general but unnecessary computing logic, thereby exhibiting efficient power and energy consumption behaviors. In some embodiments, the hardware modules of the storage card may be connected with signal ports and process I/O requests on their datapath in a pipelined manner, which can exhibit stable and sustainable thermal efficiency in a real system.

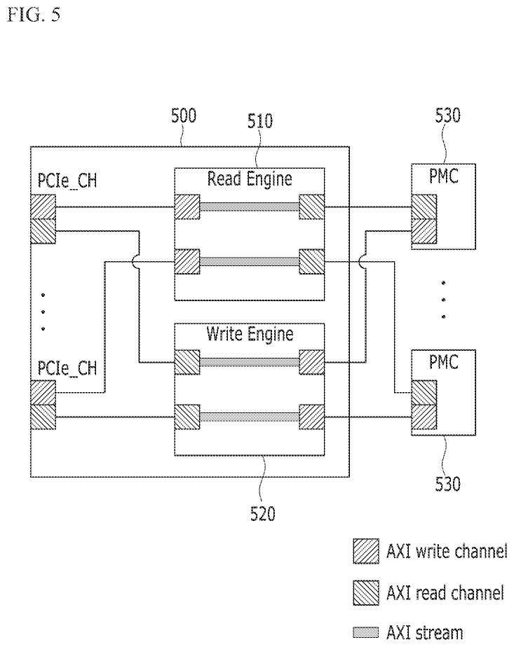

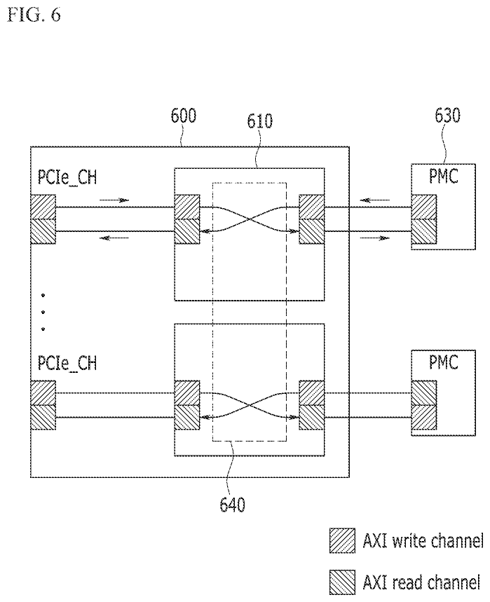

Next, embodiments of connecting a direct I/O module using an AXI interface are described with reference to FIG. 5 and FIG. 6.

FIG. 5 and FIG. 6 are drawings showing various examples of an AXI interface of a direct I/O module of a storage card according to an embodiment.

Referring to FIG. 5, each PCIe channel is connected to two AXI ports. The AXI bus may include an AXI read channel and an AXI write channel. The AXI read channel may include a read address channel for delivering an address and a read data channel for delivering data. The AXI write channel may include a write address channel for delivering an address, a write data channel for delivering data, and a write response channel for acknowledge as a receipt of write data. Thus, each PCIe channel may be connected to an AXI port for the AXI read channel and an AXI port for the AXI write channel.

As shown in FIG. 6, in some embodiments, one AXI channel may be matched with the same AXI channel on the other side. For example, when a DMA engine 610 of a direct I/O module 600 is connected to the PCIe channel through the read channel, it may be also connected to the memory controller 630 through the read channel. When the DMA engine 610 is connected to the PCIe channel through the write channel, it may also be connected to the memory controller 630 through the write channel. In a write request, the DMA engine 610 may read data from a host memory through the read channel and transfer the write data to the memory controller 630 through the write channel. In a read request, the DMA engine 610 may receive read data from the memory controller 630 through the read channel and write the read data to the host memory through the write channel. In this case, the DMA engine 610 may transfer data received through the read channel to the write channel by using the additional logic 640. In addition, the DMA engine 610 may serialize and process the read request and the write request.

Therefore, for removal of the additional logic and parallel processing of the read and write requests, in some embodiments, as shown in FIG. 5, a direct I/O module 500 may split a read engine 510 and a write engine 520. An AXI read channel and an AXI write channel may be split and connected to the read engine 510 and the write engine 520 of the direct I/O module 500. The AXI bus may be split into the AXI read channel and the AXI write channel so that each channel may be assigned to each engine separately. Specifically, in the read request, since the read data is copied (read) from the PRAM module and transferred (written) to the host memory, the read engine 510 may be connected to a memory controller 530 through the AXI read channel and may connected to a PCIe port through the AXI write channel. In the write request, since the write data is copied (read) from the host memory and transferred (written) to the PRAM module, the write engine 520 may be connected to the PCIe port through the AXI read channel and may be connected to the memory controller 530 through the AXI write channel. In addition, in each engine, the two different AXI channels may be connected directly by the AXI stream interface. That is, the read data can be transferred from the read channel to the write channel by connecting the read channel to the write channel through the AXI stream interface in the read engine 510, and the write data can be transferred from the read channel to the write channel by connecting the read channel to the write channel through the AXI stream interface in the write engine 520. Accordingly, there is no need for additional logic to transfer data within the engine, and the read request and the write request can be simultaneously processed.

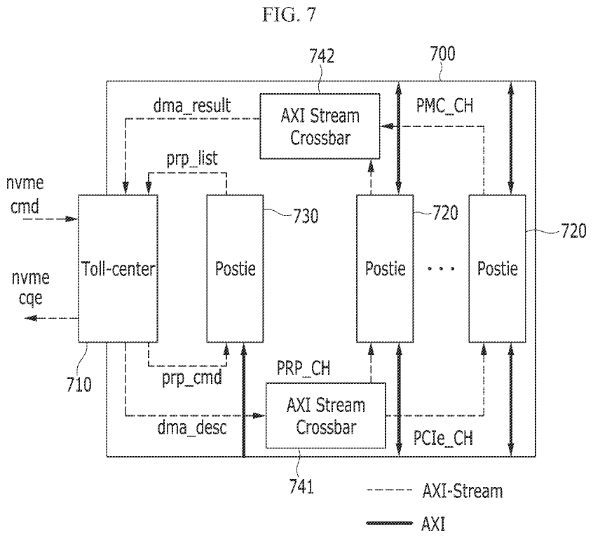

Next, embodiments of a detailed configuration of a direct I/O module is described with reference to FIG. 7.

FIG. 7 is a diagram showing an example of a direct I/O module of a storage card according to an embodiment.

Referring to FI.G. 7, an I/O engine (read engine or write engine) 700 of a direct I/O module may include a plurality of submodules, and the plurality of submodules may include a toll-center module 710 and a plurality of postie modules 720. In some embodiments, the plurality of postie modules 720 may be connected to a plurality of memory controller channels PMC_CH, respectively, and may he connected to a plurality of PCIe channels, respectively. A plurality of PRAM modules (e.g., 360 of FIG. 3) may be connected to the plurality of PMC channels PMC_CH, respectively. In some embodiments, the I/O engine 700 may further include a postie module 730 for a PRP. In some embodiments, the toll-center module 710 and the postie modules 720 and 730 may be RTL modules.

While the toll-center module 710 manages data transfer related services, the postie module 720 may transfer data between different AXI buses. The toll-center module 710 may receive request information (nvme_cmd) from a fetch module (e.g., 310 of FIG. 3) through an AXI stream, and extract information necessary for an I/O service, such as an operation code, a PRP and an LBA. The PRP may include PRP1 indicating a location of data with a predetermined size (e.g., 4 KB) in the host memory. In some embodiments, the PRP may further include PRP2 indicating a PRP list. The PRP list may be a set of pointers and may include at least one PRP entry indicating a location of data with the predetermined size (e.g., 4 KB) in the host memory. In this case, the toll-center module 710 may transfer the PRP2 to the postie module 730 through an AXI stream (e.g., prp_cmd). The postie module 730 fetches the PRP list from the host memory based on the PRP2. In some embodiments, the postie module 730 may fetch the PRP list through an AXI bus connected to a PRP channel of a PCIe interface. The postie module 730 transfers the PRP list to the toll-center module 710 through an AXI stream (e.g., prp_list).

The toll-center module 710 composes a descriptor for data transfers including an identifier of the I/O request, an operation code, a source/destination address, and a size based on the request information. In some embodiments, when the operation code indicates a read, the toll-center module 710 may set the source address by translating the LBA into a physical address of the PRAM module, and may set the destination address based on the PRP1 or PRP entry. When the operation code indicates a write, the toll-center module 710 may set the destination address by translating the LBA into the physical address of the PRAM module, and may set the source address based on the PRP1 or PRP entry. The toll-center module 710 transfers the descriptor (dma_desc) to a target postie module 720 among the plurality of postie modules 720 through an AXI stream.

As described above, since the PCIe interface and the plurality of memory controllers are directly connected using the plurality of postie modules 720 as many as the number of PMC channels, it is possible to remove a buffer and core resources required for data transfers. Each postie module 720 connects a corresponding PCIe channel and a corresponding PMC channel through an AXI bus, and obtains a direct transfer request receiving the descriptor (dma_desc) from the toll-center module 710. Accordingly, each postie module 720 may directly transfer data between the PCIe interface and the memory controller without internal buffering. When the data transfer is completed, each postie module 72( )returns a completion event (dma_result) to the toll-center module 710 through an AXI stream. In some embodiments, the plurality of AXI stream interfaces connected to the plurality of postie modules 720 respectively may be connected to the toll-center module 710 through AXI stream crossbars 741 and 742.

Upon receiving all completion events for the PO request, the toll-center module 710 sends a service completion signal (nvme_cqe) to a terminator module 730 through an AXI stream.

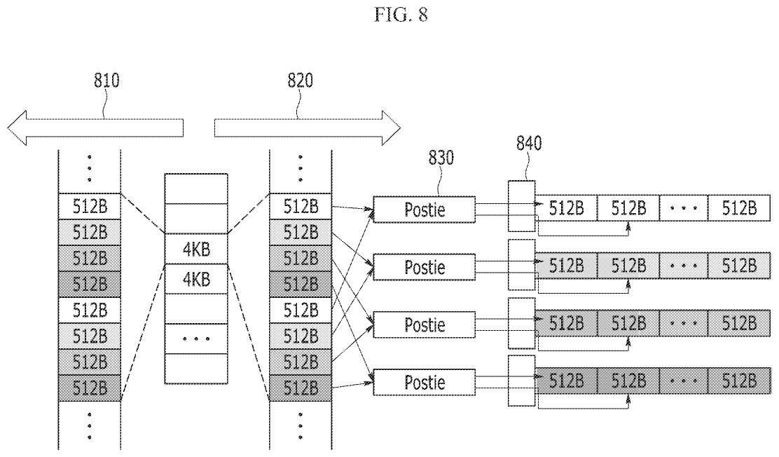

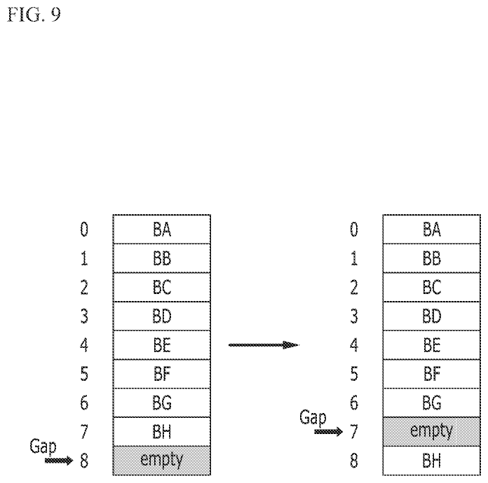

FIG. 8 is a diagram showing an example of data transfers in a storage device according to an embodiment, and FIG. 9 is a diagram for explaining an example of wear-leveling in a storage device according to an embodiment.

Referring to FIG. 8, a direct I/O module splits a host's I/O request into a set of sub-requests based on a transfer size of a postie module. Assuming that the transfer size of the postie module is, for example, 512 B, the direct I/O module may split the request into a set of sub-requests whose size is 512 B. Assuming that a size of a data block of a host memory indicated by the PRP entry is 4 KB, the toll-center module (710 of FIG. 7) of the direct I/O module may split a 4 KB data block into eight 512 B data chunks and assign the data chunks to a plurality of postie modules 830. Accordingly, the eight data chunks may be striped across a plurality of memory controller (PMC) 840, that is, a plurality of PMC channels. For example, when four PMC channels are used, as shown in FIG. 8, the toll-center module 710 may repeat an operation of sequentially assigning the eight data chunks to the four PMC channels. Although the write request has been described in FIG. 8, a read request may be processed through a similar process.

In some embodiments, a direct I/O module may further include a wear-leveling module to evenly distribute I/O requests across a plurality of backend memory modules. Referring to FIG. 9, when an address space of s backend memory (i.e., a plurality of PRAM modules) includes a plurality of blocks, the wear-leveling module may set at least one block (hereinafter referred to as a “gap block”) to which data is not written among the plurality of blocks, and may shift the gap block in the address space based on a predetermined condition. In some embodiments, the wear-leveling module may repeat an operation of checking the total number of serviced writes, shilling the gap block if the total number of serviced writes is greater than a threshold, and initializing the total number of serviced writes. For example, when there are nine blocks in the address space, the wear-leveling module may set the last block as an initial gap block (empty), and set the remaining eight blocks as data-programmable blocks (BA to BH). Whenever the total number of writes reaches the threshold, the total number of writes may be initialized and an index of the block set as the gap block can be decreased by one. In some embodiments, when the physical address translated from the logical address is greater than or equal to the address of the gap block, the wear-leveling module may increase the corresponding physical address by one block. Accordingly, it is possible to prevent the same block from being continuously programmed.

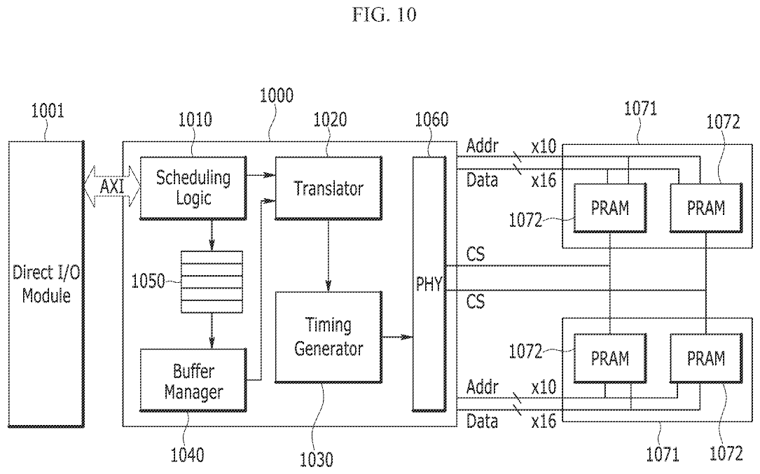

FIG. 10 is a diagram showing an example of a memory controller and a backend memory module of a storage device according to an embodiment.

Referring to FIG. 10, a memory controller 1000 includes a scheduling logic 1010, a translator 1020, a timing generator 1030, a buffer manager 1040, and a buffer 1050.

The scheduling logic 1010 separates read requests and write requests coming from a direct I/O module 1001. In some embodiments, the scheduling logic 1010 may be connected to the direct I/O module 1001 via a memory bus, for example, an AXI bus. In a read request, the scheduling logic 1010 delivers the read request to the translator 1020. The translator 1020 converts the requests of the direct I/O module 1001 into a set of memory operation commands (e.g., PRAM operation commands) which composes a memory transaction based on a standard. of a memory interface protocol. in some embodiments, the memory interface protocol may include an LPDDR2-NVM (low power double data rate 2 non-volatile memory) protocol. In some embodiments, the memory transaction may include an operation code, a target address, data, and an execution command. The timing generator 1030 manages a timing signal (e.g., a double data rate (DDR) signal) which is used for the PRAM module.

Since a write of the PRAM is slower than a read, the scheduling logic 1010 queues the write request into the buffer 1050. In some embodiments, the buffer 1050 may be implemented by a block RAM (BRAM) within the memory controller 1000. Similar to the read request, the buffer manager 1040 programs each buffer entry of the buffer 1050 into the PRAM module by collaborating with the translator 1020 and the timing generator 1030.

In some embodiments, the memory controller 1000 may use a non-blocking I/O method capable of performing a read in a partition which does not conflict with a partition in which a write is in progress, in order to maximize parallel processing within a bank-level. In some embodiments, the non-blocking I/O method may use a method disclosed in Gyuyoung Park et al., “BIBIM: A Prototype Multi-Partition Aware Heterogeneous New Memory,” in The 10th LSENIX Workshop on Hot Topics in Storage and File Systems (HotStorage), 2018, or U.S. Pat. No. 10,664,394. While the DRAM module is a set of on-chip memory arrays, called MAT, it may not allow the memory controller to manage MATs per bank individually. However, in some embodiments, each bank die of the PRAM module may include a plurality of partitions that operate independently. In some embodiments, at the bottom of the memory controller 1000, a PRAM physical layer (PHY) 1060 may he implemented for communication with the PRAM module. The PHY 1060 may convert an analog signal into a digital signal (event) or a digital signal into an analog signal, and may mitigate a working frequency difference of between the PRAM module and FPGA-side control logic.

In some embodiments, to enhance the degree of parallelism, a PRAM module connected to one channel (i.e., one memory controller 1000) may be split into two PRAM data bus groups, each called a gang 1070. Each gang 1070 may include a plurality of PRAM packages 1071 that share address, control, and data signal wires. For convenience of description, it is shown in FIG. 10 that each gang 1070 includes two PRAM packages 1071. In some embodiments, the PRAM package 1071 may be connected to the corresponding memory controller 1000 through an address signal wire Addr (e.g., 10 bits) and a data signal wire Data (e.g., 16 bits). In addition, the PRAM package 1071 may support a burst data transfer (e.g., 32 B) for a high bandwidth memory access. While I/O signals may be shared within the gang 1070, the memory controller 1000 may select an individual PRAM package 1071 over a separate chip selection signal CS that interfaces with each PRAM package 1071 in the gang 1070. Therefore, when the memory controller 1000 enables the corresponding channel, two PRAM packages 1071 across different gangs 1070 may service memory requests in parallel.

In some embodiments, a direct I/O module may be placed in the middle of an FPGA board to communicate well with other modules including memory controllers, in the storage card. A fetch module and a terminator module may be placed in the outermost (e.g., in the right most of the middle) of the FPGA board.

While this invention has been described in connection with what is presently considered to be various embodiments, it is to be understood that the invention is not limited to the disclosed embodiments. On the contrary, it is intended to cover various modifications and equivalent arrangements included within the spirit and scope of the appended claims.

What is claimed is:

1. A storage card configured to connect a non-volatile memory module and a host including a processor and a host memory, the storage card comprising:
a first module that exposes a set of registers including a first register to the host through a configuration space of a host interface for connection with the host, the first register being written when the host submits a command of an I/O (input/output) request to the host memory;
a second module that fetches the command from the host memory when the first register is written;
a third module that detects a location of the host memory based on a host memory address of request information included in the command in response to signaling of the second module, and performs a transfer of target data for the I/O request between the host memory and a memory controller for the non-volatile memory module; and
a fourth module that writes a completion event to the host memory through the configuration space in response to service completion of the I/O request in the third module, and informs the host about I/O completion by writing an interrupt.

2. The storage card of claim 1, wherein the first module, the second module, the third module, and the fourth module are implemented as hardware.

3. The storage card of claim 2, wherein the first module, the second module, the third module, and the fourth module are implemented as the hardware at a register transfer level (RTL).

1. The storage card of claim 1, wherein the first module, the second module, the third module, and the fourth module are connected by an internal memory bus of the storage card.

5. The storage card of claim 1, wherein the host interface includes a peripheral component interconnect express (PCIe) interface, and
wherein the configuration space includes base address registers (BARs).

6. The storage card of claim 1, wherein the set of registers further includes a second register, and
wherein the second register is written in response to the fourth module notifying the host of completion of the I/O request.

7. The storage card of claim 1, wherein the third module translates a logical address of the request information into a physical address of the non-volatile memory module.

8. The storage card of claim 1, wherein the host memory address includes a PRP (physical region page).

9. The storage card of claim 1, wherein the third module includes a plurality of I/O engines, and
wherein the plurality of I/O engines include a read engine that reads data from the non-volatile memory module, and a write engine that writes data to the non-volatile memory module.

10. The storage card of claim 9, wherein each I/O engine includes a plurality of submodules, and
wherein the plurality of submodules include:
a first submodule that extracts information including an operation code indicating a read or a write, a PRP, and a logical address from the request information received from the second module, composes a descriptor including the operation code, a source address, and a destination address based on the extracted information, and sends a signal indicating the service completion to the fourth module when receiving a completion event; and
at least one second submodule that receives the descriptor from the first submodule, performs the transfer of the target data between the host memory and the memory controller based on the descriptor, and returns the completion event to the first submodule when the transfer is completed.

11. The storage card of claim 10, wherein the plurality of submodules further include a third submodule,
wherein when the PRP includes PRP1 and PRP2, the first submodule transfers the PRP2 to the third submodule, and the third submodule fetches a PRP list indicated by the PRP2 from the host memory and transfers the PRP list to the first submodule, and
wherein the first submodule sets the source address or destination address based on the PRP1 and the PRP list.

12. The storage card of claim 10, wherein the at least one second submodule includes a plurality of second submodules corresponding to a plurality of channels for the memory controller, respectively, and
wherein the first submodule transfers the descriptor to a target second submodule among the plurality of second submodules.

13. The storage card of claim 12, wherein the first submodule splits a block of the target data into a plurality of data chunks, and assigns the plurality of data chunks to the plurality of second submodules.

14. The storage card of claim 10, wherein the first module, the second module, the third module, and the fourth module are connected to the host interface through a first type of memory bus,
wherein the plurality of submodules are connected to each other through a second type of memory bus, and
wherein the third module is connected to the second module and the fourth module through the second type of memory bus.

15. The storage card of claim 14, wherein the first type of memory bus includes an advanced extensible interface (AXI) bus, and
wherein the second type of memory bus includes an AXI stream bus.

16. The storage card of claim 12, wherein the non-volatile memory module includes a plurality of memory modules,
wherein the memory controller includes a plurality of memory controllers connected to the plurality of memory modules, respectively, and
wherein the of memory controllers are connected to the plurality of channels, respectively.

17. The storage card of claim 9, wherein the read engine is connected to a write port of the host interface through a first write channel, and is connected to a read port of the memory controller through a first read channel,
wherein the write engine is connected to a read port of the host interface through a second read channel, and is connected to a write port of the memory controller through a second write channel,
wherein the first write channel and the first read channel are connected by a first unidirectional bus, and
wherein the second read channel and the second write channel are connected by a second unidirectional bus.

18. The storage card of claim 17, wherein AXI buses are split into the first write channel and the first read channel, and split into the second write channel and the second read channel, and
wherein the first and second unidirectionalbuses include AXI stream buses.

19. A storage card configured to connect a non-volatile memory module and a host including a processor and a host memory, the storage card comprising:
a memory controller connected to non-volatile memory module;
a first module that exposes a set of registers to the host through BARs (base address registers) of a PCIe (peripheral component interconnect express) interface;
a second module that fetches a command of an I/O (input/output) request from the host memory when the set of registers is written;
a third module that detects a location of the host memory based on a PRP (physical region page) of request information included in the command in response to signaling of the second module, and performs a transfer of target data for the I/O request between the host memory and the memory controller; and
a fourth module that writes a completion event to the host memory through the BARs in response to service completion of the I/O request in the third module, and informs the host about I/O completion by writing an interrupt,
wherein the first module, the second module, the third module, and the fourth module are implemented as hardware.

20. A storage device configured to be connected to a host including a processor and a host memory, the storage device comprising:
a non-volatile memory module;
a memory controller connected to non-volatile memory module;
a first module that exposes a set of registers including a first register to the host through a configuration space of a host interffice for connection with the host, the first register being written when the host submits a command of an I/O (input/output) request to the host memory;
a second module that fetches the command from the host memory when the first register is written;
a third module that detects a location of the host memory based on a host memory address of request information included in the command in response to signaling of the second module, and performs a transfer of target data for the I/O request between the host memory and a memory controller for the non-volatile memory module; and
a fourth module that writes a completion event to the host memory through the configuration space in response to service completion of the I/O request in the third module, and informs the host about I/O completion by writing an interrupt.
